(19) United States
(12) Patent Application Publication
(10) Pub. No.: US 2009/0187892 A1
(43) Pub. Date: Jul. 23, 2009

(54) APPARATUS AND PROGRAM FOR TEST CASE GENERATION

(75) Inventors: Masaya Ohi, Okazaki-city (JP); Yoshitaka Uematsu, Anjo-city (JP); Yoshiyuki Maki, Inazawa-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/354,369

(22) Filed: Jan. 15, 2009

(30) Foreign Application Priority Data
Jan. 18, 2008 (JP) 2008-9252

(51) Int. Cl. G06F 9/44

(52) U.S. Cl. 717/126

(57) ABSTRACT

A test case generation apparatus checks if there is a source code inspected portion in a model that is used to generate a test case. The inspected portion in the model is determined based on inspection information, and, when the inspected portion is found in the model, the inspected portion of the model is simplified. Thus, the test case generated by the test case generation apparatus has a fewer number of test patterns due to the simplified model of the inspected portion, and, as a result, achieves an enhancement of performance limit of an automatic test case generation of the test case generation apparatus.

### CROSS REFERENCE TO RELATED APPLICATION

The present application is based on and claims the benefit of priority of Japanese Patent Applications No. 2008-9252, filed on Jan. 18, 2008, the disclosure of which is incorporated herein by reference.

### FIELD OF THE INVENTION

The present disclosure generally relates to a test case generation apparatus for automatic test case generation.

### BACKGROUND INFORMATION

Conventionally, a “model” based development has been employed for developing signal input/output programs for the purpose of achieving ease of code generation and improved visibility/readability, when, for example, electronic control units (ECU) control system programs or other control system programs are developed. That is, the model based development of the program may make it easier for the developer to implement required functions of the programs, in comparison to the direct source code development.

The developer uses model based development environment installed on a server/workstation or the like to perform simulation of the model, and to generate the source code of model-defined data input/output.

As an example of the model based development based on a model to source code development scheme, MathWork's MATLAB (registered trademark) is well known. MATLAB software enables the developer to define a data input/output model with the assistance of an additional module of Simulink (registered trademark).

The model used in the model based development uses blocks and connection lines as its components. That is, the model represents data operation function and data input/output function by using blocks as those function blocks, and represents inter-block input/output relationships by using connection lines. In other words, the function blocks inter-connected by the connection lines, as an integrated set of vehicle control functions for example, serves as a model.

In the model based development environment, model-to-source-code conversion is inspected in terms of appropriateness to the intended functionality. The inspection is performed by using test input data (i.e., test cases) for the purpose of maximizing the coverage of the modeled process such as branch instructions and the like. That is, the model inspection aims at performing as many branch courses of processes as possible for verification of the appropriate conversion from the model to the source code.

Further, the test case is now automatically generated by using a technique disclosed, for example, in Japanese patent document JP-A-2006-24006 (also published as US patent document 2006/0010429). In the above disclosure, the technique is described as an automatic generation of the test cases based on an analysis of the branch logics and the like in the model, for the purpose of maximum coverage of multiple logical paths.

However, the automatic test case generation may yield a false result, or may take too much time for test case generation, when the defined model is complicated in terms of limitation of the workstation's capacity. In that case, the test case has to be generated manually, and, as a result, the efficiency of the software development may be deteriorated in spite of the use of the automatic test case generation.

### SUMMARY OF THE INVENTION

In view of the above and other problems, the present disclosure provides an apparatus and method for easing the limitation of performance of automatic test case generation.

In an aspect of the present disclosure, a test case generation apparatus for generating, based a the process model, a test case that inspects a source code that is generated from the process model, includes: a determination unit for determining whether or not an inspected portion exists in the process model that is used to generate the test case based on inspection information that is capable of specifying the inspected portion; and a generation unit for generating the test case by using a simplified process model when the inspected portion is determined to be existing in the process model by the determination unit. In the above configuration, the simplified process model has a simplified portion in the process model in correspondence to the inspected portion of the source code.

Therefore, the simplified model may be effectively used for reduced test case generation time and for enhancement of performance limitation of the software in, for example, the development of the vehicle control software or the like, which is often developed by modifying the existing product. That is, the software development based on the existing software product, there are, in many cases, the inspected portion of the source code, and the inspected portion may safely be omitted from the inspection of the newly developed model and the source code.

As a result, the test case generation apparatus of the present disclosure achieves the enhancement of the performance limit of the test case generation by simplifying the model used for the test case generation and reducing the number of generated test case patterns. In other words, complicated models can be used for automatically generating the test case.

Further, the test case generation apparatus described above may be implemented as a software product for controlling a computer. That is, a general purpose computer may serve as the test case generation apparatus when the software product of the present disclosure is implemented for performing controls of the intended functions of the present disclosure.

### BRIEF DESCRIPTION OF THE DRAWINGS

Objects, features, and advantages of the present disclosure will become more apparent from the following detailed description made with reference to the accompanying drawings, in which:

FIG. 1 is a block diagram of a personal computer in an embodiment of the present invention;

FIGS. 2A and 2B are illustrations of a model and a test case;

FIG. 3 is a flow chart of an automatic test case generation process;

FIG. 4 is an illustration of a model that has inspection information embedded as attribute information;

FIG. 5 is an illustration of a simplified model that has a branch processing of an inspected part fixed to only one route;

FIG. 6 is an illustration of a model that has inspection information stored in a database;

FIG. 7 is an illustration of a model that has model data stored in a database as the inspection information,

FIG. 8 is an illustration of new model generation based on an inspected model stored in the database;

FIG. 9 is an illustration of an inspected model that has a source code stored in the database; and

FIG. 10 is an illustration of a simplified model that has the inspected part deleted therefrom.

### DETAILED DESCRIPTION

Hereafter, with reference to the drawing, the embodiments of the present invention are described.

### First Embodiment

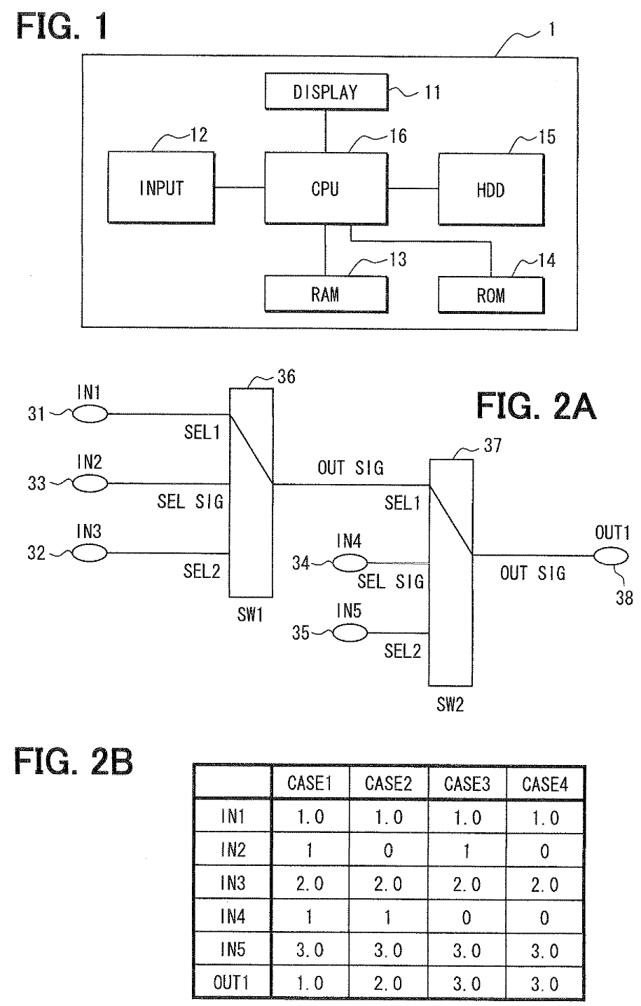

FIG. 1 is a block diagram of the composition of a personal computer 1 as the device of test case generation in the first embodiment of the present invention.

The personal computer 1 includes a display 11, an input unit 12, RAM 13, ROM 14, a hard disk drive (HDD) 15, and a central processing unit (CPU: an arithmetic unit) 16 as shown in the figure.

The display 11 displays the image signal received from the CPU 16 for the user as an image. The input unit 12 is composed of the keyboard and the mouse or the like, and when the user operates the input unit 12, it outputs, to the CPU 16, the signal corresponding to the operation.

The RAM 13 is a readable/writable volatile memory, and the ROM 14 is a non-volatile read-only memory. Further, the HDD 15 is a readable/writable non-volatile memory. The programs or the like that the CPU 16 reads and executes are pre-memorized in the ROM 14 and the HDD 15. Moreover, the “models” described later is memorized in the HDD 15.

When the program memorized in the ROM 14 and the HDD 15 is executed by the CPU 16, the RAM 13 serves as a temporary storage area to preserve the program and the work data.

The CPU 16 reads and executes a prescribed boot program from the ROM 14 when the power supply for the personal computer 1 is started, and performs initial processing by reading, from the HDD 15, and executing programs such as operating system (OS) defined in the boot program. The CPU 16 executes various programs recorded on the HDD 15 as a process in OS from the start to the termination of the power supply until on the basis of the schedule set beforehand, signals from the input unit 12 or the like. Moreover, the CPU 16 accepts the input of signals from the input unit 12 as required, outputs the image signal to the display 11, and controls reading/writing data for the RAM 13 and the HDD 15 in the above-mentioned initial processing and other processes.

Then, the outline of the processing executed by the personal computer 1 is described. The personal computer 1 generates, according to a model, a test case to inspect a source code (for instance, a source code of C language to be executed in an ECU for vehicle control) generated on the basis of the above-mentioned model which represents processing contents.

The model is described as a combination of a function block (i.e., a subsystem) representing at least one of data operation, data input, and data output respectively performed in a time series, and a connecting line representing inter-block input/output relationship. Simulink (registered trademark) model of MathWorks Co. may serve as an example of the “model.”

FIG. 2A shows one example of the model. In the model, FIGS. 31 to 38 represent “blocks,” and the lines connecting between those blocks represent “connecting lines.” In the diagram in FIG. 2A, input blocks 31 to 35 represent a function for receiving data as an input from outside, and for outputting the received data to the latter part of the connecting lines. Switch blocks 36 and 37 output the value of selection 1 as an output signal when the input selection signal is “1,” or output the value of selection 2 as an output signal when the input selection signal is “0.” In the present model, each of the three connecting lines is used to input, to the switch blocks 36 and 37, one of the value of the selection 1, the selection signal, and the selection 2. On the other hand, an output block 38 has a function to output the data received through connecting lines to an outside of the block.

The source code describing the processing to realize the data I/O processing that is represented by a model is generated on the basis of such a model. In addition, the source code generation may be performed either automatically based on the model, or manually by the programmer.

Then, the generated source code is inspected by using a test case (That is, variety of input data with which a largest possible number of instructions from among all instructions in the source code are executed. In other words, a largest possible numbers of blocks in the model are designed to be passed through by having a set of inputs that combines small numbers of inputs). For instance, the model of FIG. 2A can be inspected by using the test case shown in FIG. 2B. In the test case, the four combinations of input 2 (IN2) and input 4 (IN4) that serve as selection signals of the switch blocks 36 and 37 are respectively tested.

The source code generated on the basis of the model is inspected by using such a test case. More practically, by using the test case, a model simulation is performed with the source code (i.e., the source code based on the model) being executed for determining whether the both results (i.e., outputs) are matching. The model simulation is, in this case, the reproduction of the modeled input/output variably correlated along the time scale as a process on the personal computer 1.

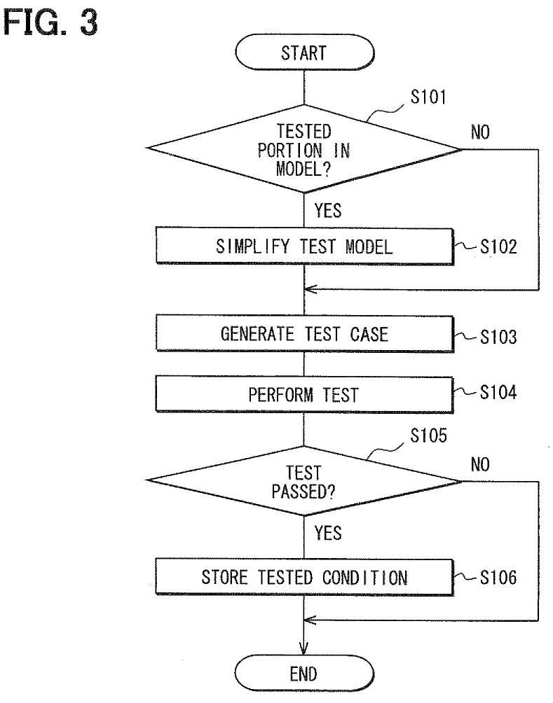

Next, a flow chart of FIG. 3 is used to describe the automatic test case generation processing that the CPU 16 perform for generating the test case with the test case generation apparatus of the present embodiment. The test case generation processing by the apparatus starts upon having a user input that starts the processing from the input unit 12.

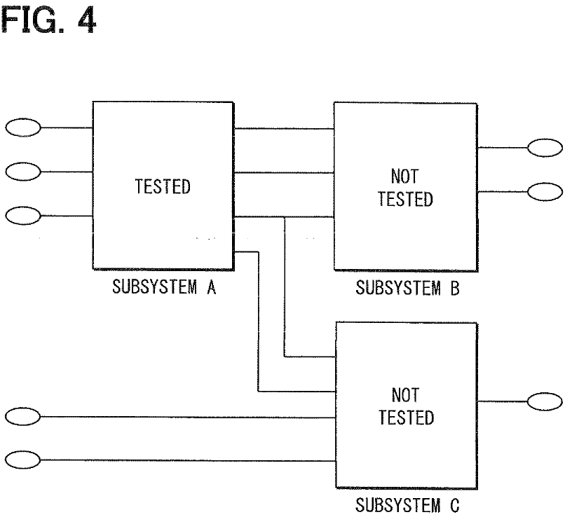

The CPU 16 determines whether, in S101, an inspection target model has an inspected part that has already been inspected in terms of source code inspection when the automatic test case generation processing is started. In the present embodiment, inspection information that can identify a part that has been inspected (information that shows inspected part) is buried as attribute information in each block, and it can be determined whether there has been an inspected part by seeing the attribute information in each block of the inspection target model (i.e., a model that serves as a target object of the inspection). For instance, the model shown in FIG. 4 consists of subsystems A to C, and information that shows that the subsystem has been inspected is memorized in the subsystem A as the attribute information, and information that shows the un-inspection (i.e., a condition of being not-yet inspected) is memorized in the subsystems B and C as attribute information. How the inspection information (inspected/not-yet inspected) is written is described later (S106).

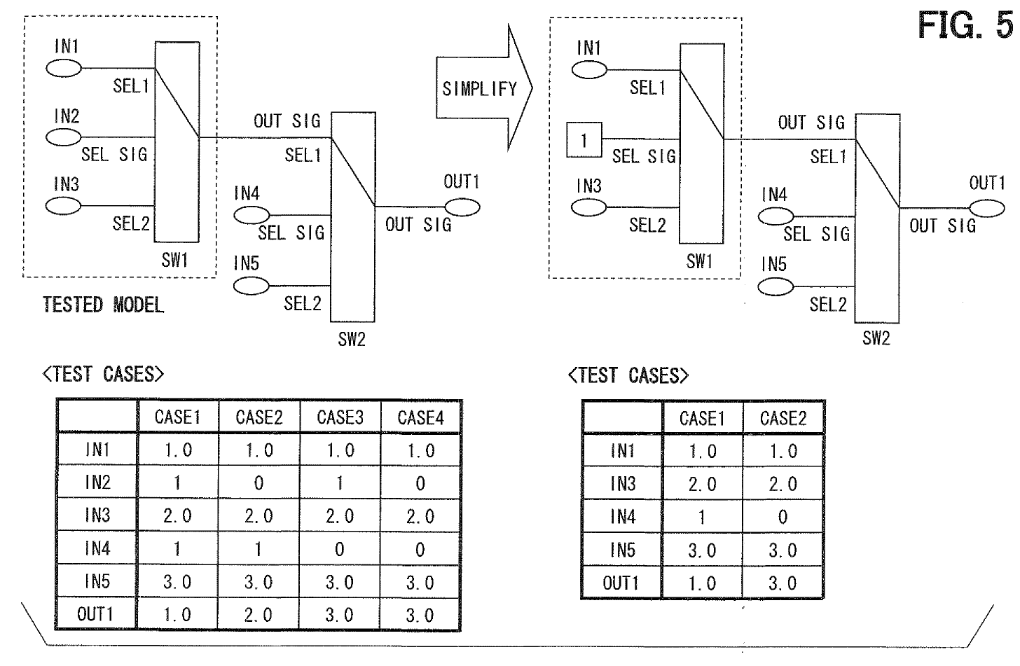

Then, after determining that the model to be inspected has the tested part in S101, the process proceeds to S102. The tested part is simplified for the simplification of the model before the process proceeds to S103. More practically, the model is simplified by fixing the branch processing that has been inspected to only one branch route. For instance, the model has been simplified by fixing the value of input 2 (selection signal of switch 1) to “1” in the example shown in FIG. 5. In this case, the branch fixation may be performed by preparing a partial substitution model that replaces the inspected part.

On the other hand, the process proceeds to S103 when it is determined that the model does not have the inspected part in S101. In S103, the test case is generated on the basis of the target model (e.g., the model simplified in S102 as required) that is to be inspected.

Then, in S104, the source code that has been separately generated on the basis of the target model is inspected by using the test case generated in S103. Then, in S105, the inspection result is examined if the inspection in S104 is passed or not.

Then, the process proceeds to S106 when it is determined that the inspection result indicates “passed” in S105, and the inspection information that shows the inspection is complete as the attribute information of the target model is written. Then, the automatic test case generation processing is ended.

On the other hand, the automatic test case generation processing is ended without any subsequent processing when it is determined that the inspection result indicates “not passed” in S105.

As described above, the personal computer 1 determines whether or not there exists an inspected part in the target model (S101), and generates the test case based on the simplified model that has the simplified inspected part in the model, if there is the inspected part in the model (S101:YES) (S102, S103). The operation scheme in the first embodiment, therefore, enables the reduction of the number of inspection patterns generated for the inspection. As a result, the performance limit of the automatic test case generation can be enhanced.

Moreover, because it is determined whether the inspected part exists on the basis of the attribute information embedded in the model, the inspected part can be easily and securely identified by the personal computer 1. In particular, the personal computer 1 writes the information that shows that the inspection of the model is complete as the attribute information of the model (S106), when the inspection of the source code by using the generated test case (S104) shows the “passed” result (S105:YES). Therefore, the information that shows that the inspection is complete can be automatically written as the attribute information in the model.

In addition, the model can be simplified by the personal computer 1 without greatly changing the model's composition because the model has been simplified by fixing the branch processing in the inspected part of the model.

In the personal computer 1 of the first embodiment, the CPU 16 that executes the processing of S101 corresponds to the determination unit, and the CPU 16 executing the processing of S102 and S103 corresponds to the generation unit in the claim language. Further, the CPU 16 executing the processing of S104 corresponds to the inspection unit, and the CPU 16 executing the processing of S105 and S106 corresponds to write unit in the claim language.

### Second Embodiment

The personal computer 1 in the second embodiment is described. The method of determining whether there is an inspected part in the model is different in the present embodiment, though the basic configuration of the personal computer 1 is same as the one in the first embodiment shown in FIG. 1. Therefore, like numbers are used to indicate like parts in the present embodiment and the first embodiment, and the description of the like parts are omitted.

The CPU 16 in the personal computer 1 of the present embodiment executes the automatic test case generation processing shown in FIG. 3 that is basically similar to the one in the first embodiment. However, processing contents in S101 and S106 are different from the first embodiment.

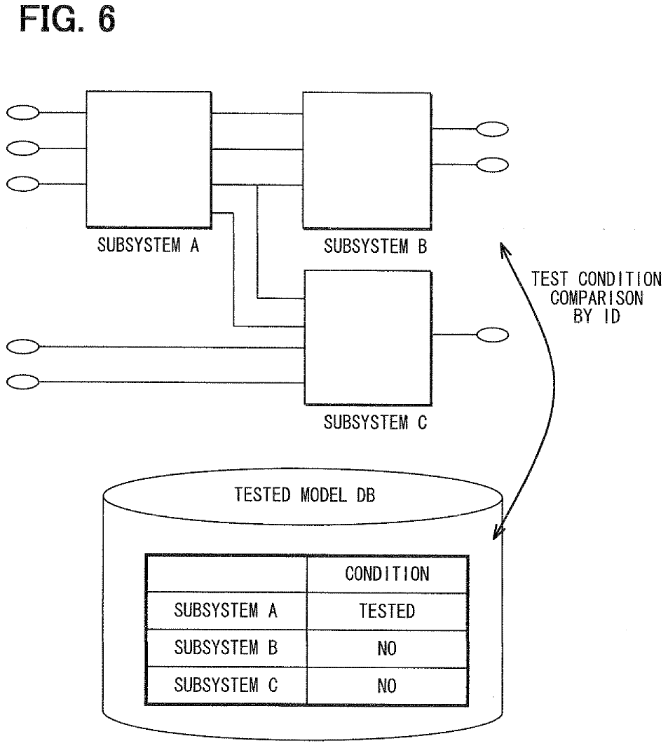

In S101, it is determined whether the inspected part exists in the target model. In the present embodiment, the identification information of the model (e.g., the inspected block) which has been inspected, that is, a subsystem name, for instance, is memorized in the database on the HDD 15 as the inspection information (i.e., inspection execution history information), and it is determined whether some of the blocks that constitute the model have been inspected by referring to the database. For instance, the model shown in FIG. 6 consists of the subsystem A to C, and the inspection information that shows that the subsystem A has been inspected is memorized in the database.

Moreover, in S106, the model name (e.g., a subsystem name serving as an ID) is written in the HDD 15 as the inspection information of the target model that is to be inspected. For instance, it is possible to memorize the information as a data file in an existing spreadsheet format.

As described above, the personal computer 1 of the second embodiment determines whether the inspected part exists based on the inspection information stored in the database, thereby enabling an easy and secure way for identifying the inspected part of the model without embedding extra information in the model. Moreover, the database of the inspection information may be implemented on a server computer for a centralized control. In particular, because the inspection information is stored in the database as the identification information of the model, the data volume of the inspection information memorized as the inspection information can be reduced.

### Third Embodiment

The personal computer 1 in the second embodiment is described. The method of determining whether there is an inspected part in the model is different in the present embodiment, though the basic configuration of the personal computer 1 is same as the one in the first embodiment shown in FIG. 1. Therefore, like numbers are used to indicate like parts in the present embodiment and the first embodiment, and the description of the like parts are omitted.

The CPU 16 in the personal computer 1 of the present embodiment executes the automatic test case generation processing shown in FIG. 3 that is basically similar to the one in the first embodiment. However, processing contents in S101 and S106 are different from the first embodiment.

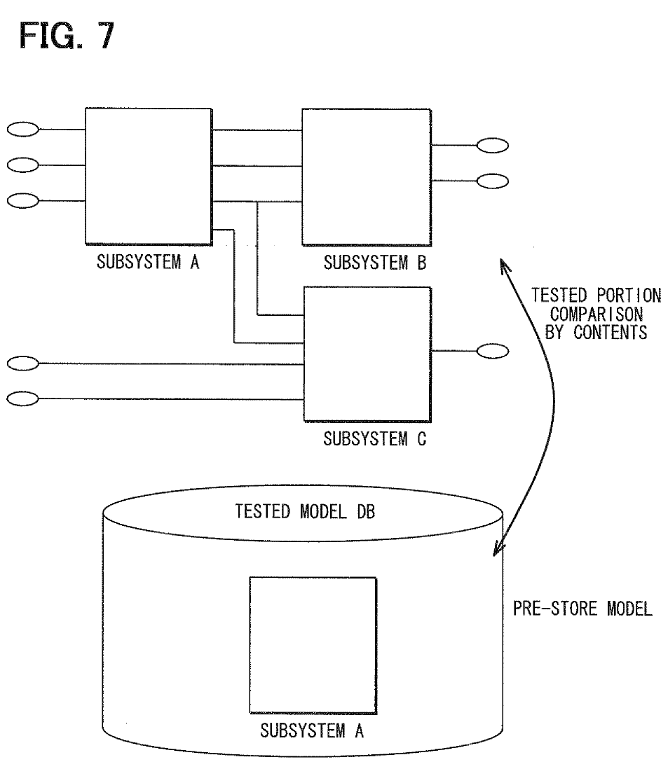

In S101, it is determined whether the inspected part exists in the target model. In the present embodiment, the data of the inspected model itself is memorized in the data base of the HDD 15 as the inspection information, and it is determined whether there are blocks in the model that have been inspected based on the pattern matching of the subsystem contents with reference to the memorized data. For instance, the model shown in FIG. 7 consists of the subsystems A to C, and the data of the subsystem A is memorized in the database as the inspection information.

Moreover, the data of the model is written in the HDD 15 as the inspection information of the target model that is to be inspected in S106.

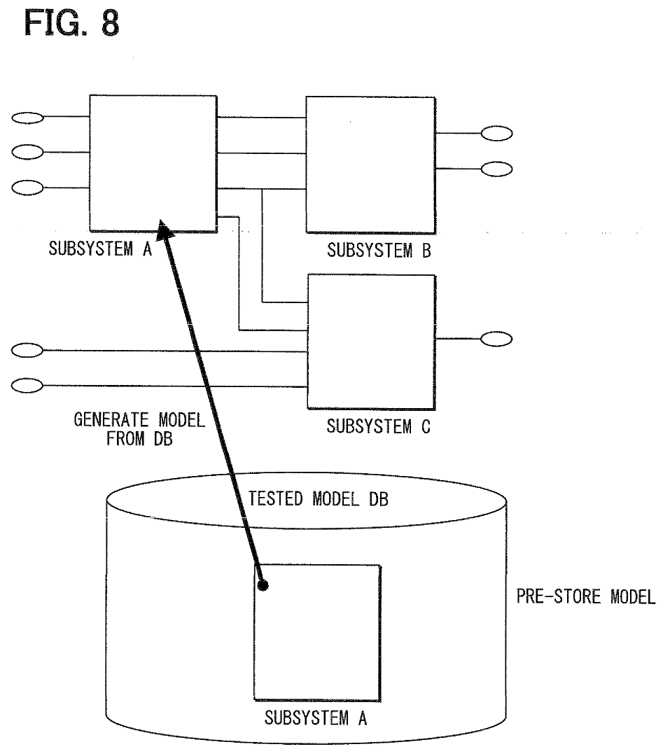

As described above, the personal computer 1 in the present embodiment stores the model data itself thereby enabling flexible identification of the model even when a fraction of the model is changed. That is, even when a part of the model such as the subsystem name, block coordinates offset in the model editor or the like has been changed, the model can be determined as identical if the same logic is implemented by the model. In addition, a new model can be efficiently generated by using (i.e., by library-link reference to) the inspected model that is memorized in the database as shown in FIG. 8.

### Fourth Embodiment

The personal computer 1 in the second embodiment is described. The method of determining whether there is an inspected part in the model is different in the present embodiment, though the basic configuration of the personal computer 1 is same as the one in the first embodiment shown in FIG. 1. Therefore, like numbers are used to indicate like parts in the present embodiment and the first embodiment, and the description of the like parts are omitted.

The CPU 16 in the personal computer 1 of the present embodiment executes the automatic test case generation processing shown in FIG. 3 that is basically similar to the one in the first embodiment. However, processing contents in S101 and S106 are different from the first embodiment.

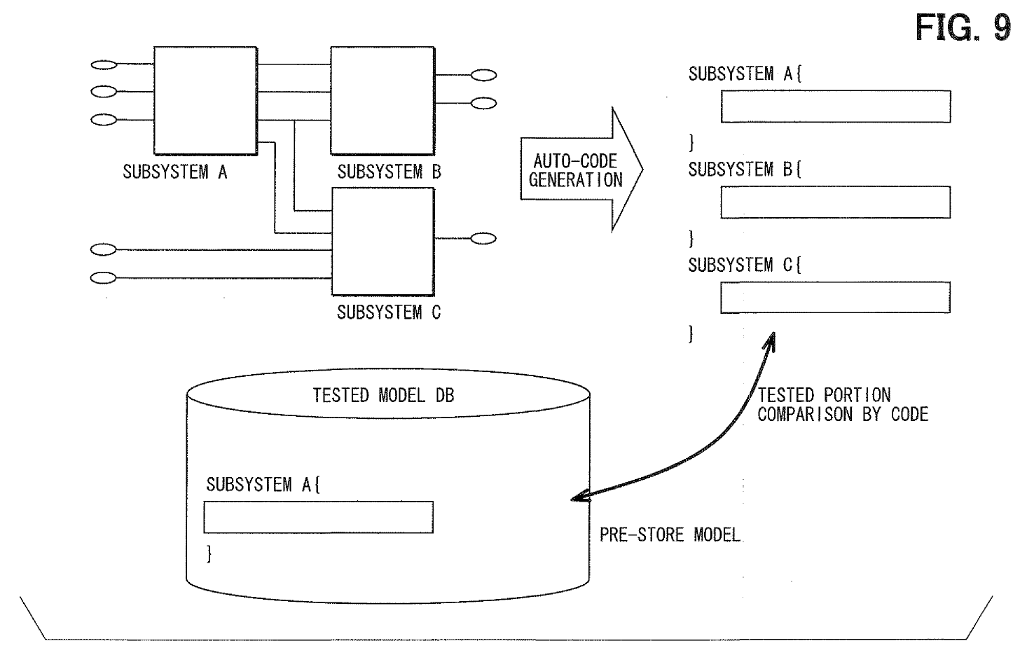

In S101, it is determined whether the inspected part exists in the target model. In the present embodiment, the source code that corresponds to the inspected model is memorized in the data base of the HDD 15 as the inspection information, and it is determined whether there are blocks in the model that have been inspected based on the source code matching. For instance, the model shown in FIG. 9 consists of the subsystems A to C, and the source code of the subsystem A is memorized in the database as the inspection information.

Moreover, the source code of the model is written in the HDD 15 as the inspection information of the target model that is to be inspected in S106.

As described above, the personal computer 1 in the present embodiment stores the source code of the model, thereby enabling the same advantageous effects as the third embodiment.

### Modifications of the Embodiments

Although the present disclosure has been fully described in connection with preferred embodiment thereof with reference to the accompanying drawings, it is to be noted that various changes and modifications will become apparent to those skilled in the art.

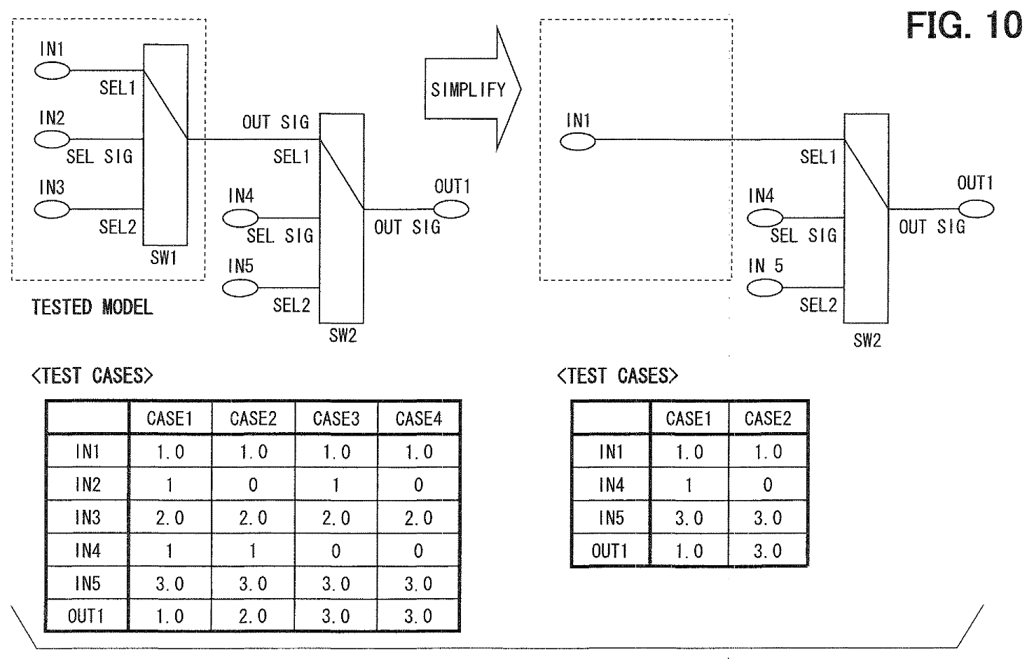

The simplification of the model may be achieved not only by fixing the branch options to only one route as shown in the above embodiments, but also by, for example, deleting the logic of the inspected part of the model as shown in FIG. 10. In this manner, the model is efficiently simplified.

Further, the source code inspection may be successively performed after the test case generation in the above embodiments. However, the source code inspection may be separately performed from the test case generation.

Furthermore, the inspection information indicating that the inspection is complete is automatically written in the above embodiments. However, the inspection information may be manually written by, for example, the model generation engineer at the time of model generation.

Such changes, modifications, and summarized scheme are to be understood as being within the scope of the present disclosure as defined by appended claims.

What is claimed is:

1. A test case generation apparatus for generating, based on a process model, a test case that inspects a source code that is generated from the process model, the apparatus comprising:
a determination unit for determining whether or not an inspected portion exists in the process model that is used to generate the test case based on inspection information that is capable of specifying the inspected portion, wherein an inspection of the source code corresponding to the inspected portion of the process model is complete; and
a generation unit for generating the test case by using a simplified process model when the inspected portion is determined to be existing in the process model by the determination unit, wherein the simplified process model has a simplified portion in the process model in correspondence to the inspected portion of the source code.

2. The test case generation apparatus of claim 1, wherein
the determination unit determines whether or not the inspected portion exists based on the test information that is embedded in the process model as model attributes.

3. The test case generation apparatus of claim 2 further comprising:
an inspection unit for performing an inspection of the source code by using the test case generated by the generation unit; and
a write unit for writing inspection information indicative of passing the test as the model attributes of the process model if the inspection unit yields an affirmative inspection result.

4. The test case generation apparatus of claim 1, wherein
the determination unit determines whether or not the inspected portion exists based on the inspection information stored in a database.

5. The test case generation apparatus of claim 4, wherein
the database stores identification information of the inspected portion of the process model as the inspection information.

6. The test case generation apparatus of claim 4, wherein
the database stores the data of the inspected portion of the process model as the inspection information.

7. The test case generation apparatus of claim 4, wherein
the database stores the source code that corresponds to the inspected portion of the process model as the inspection information.

8. The test case generation apparatus of claim 4 further comprising:
an inspection unit for performing an inspection of the source code by using the test case generated by the generation unit; and
a write unit for writing inspection information indicative of passing the test as the model attributes of the process model if the inspection unit yields an affirmative inspection result.

9. The test case generation apparatus of claim 1, wherein
the generation unit simplifies the process model by allowing only one branch path for branch processing in the inspected portion of the process model.

10. The test case generation apparatus of claim 1, wherein
the generation unit simplifies the process model by deleting the inspected portion of the process model.

11. A computer program product comprising one or more computer readable media storing computer executable instructions that implement a test case generation apparatus for generating a test case that inspects a source code that is generated from a process model, the instructions comprising:
determining whether or not an inspected portion exists in the process model that is used to generate the test case based on inspection information that is capable of specifying the inspected portion, wherein the inspected portion indicates a portion of the process model with a source code inspection having been completed; and
generating the test case by using a simplified process model when the inspected portion is determined to be existing by the determination unit, wherein the simplified process model has the inspected portion simplified in the process model.
